(19) United States
(12) Patent Application Publication
(10) Pub. No.: US 2010/0042954 A1
(43) Pub. Date: Feb. 18, 2010

(54) Motion based input selection

(75) Inventors: Michael Rosenblatt, Campbell, CA (US); Gloria Lin, San Ramon, CA (US); Sean Anthony Mayo, Dover, NH (US); Taido Lantz Nakajima, Mill Creek, WA (US)

Correspondence Address: APPLE INC.;c/o Fletcher Yoder, PC, P.O. Box 692289, Houston, TX, 77269-2289, US

(73) Assignee: Apple Inc.

(21) Appl. No.: 12/228,369

(22) Filed: Aug. 12, 2008

(51) Int. Cl. G06F 3/01

(52) U.S. Cl. 715/863

(57) ABSTRACT

A method for selecting an input value based on sensed motion is provided. In one embodiment, the method includes varying a graphical element displayed on a handheld device in response to sensed motion to identify an input value. The motion-based input may be used to perform a function on the handheld device or on an external device. For example, the input may be used to open a lock or to rotate a displayed image. Various additional methods, devices, and systems employing motion-based inputs are also provided.

### BACKGROUND

1. Field of the Invention

Embodiments of the present disclosure relate generally to handheld electronic devices and, more particularly, to graphical user interfaces configured to receive motion based inputs.

2. Description of the Related Art

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Handheld electronic devices, such as cellular telephones, portable media players, and personal data assistants, increasingly include a graphical user interface (“GUI”) for allowing interaction between the user and the device. Typical GUIs may include a system of windows, icons, menus, and pointing devices to allow navigation through applications of the electronic device. The GUI generally includes an output device, such as a Liquid Crystal Display (LCD), for displaying the windows, icons, and menus, as well as text and graphics that may be arranged as a series of screens, layers, and templates. One or more input devices, such as buttons, wheels, and a touch screen, may be used for navigating through the windows, icons, and menus.

GUIs generally aim to provide an intuitive and realistic interaction experience for a user. For example, a user may drag a scroll bar displayed on a touch screen in the downward direction to display a lower portion of a window. In another example, a user may press a button to select an item in a menu. However, typical GUIs require user manipulation of a feature of the device, such as a button or a graphical element displayed on the touch screen, providing a less realistic experience for motion based activities.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure generally relates to techniques for selecting an input value based on sensed motion. In accordance with one disclosed embodiment, an electronic device may include a GUI with graphical elements that may be varied in response to sensed motion. As the graphical elements are varied, different input values may be selected. For example, in one embodiment, the GUI may display a dial and pointer that rotates in response to motion of the device to identify input values. In accordance with another disclosed embodiment, the device may include a GUI that simulates rolling a die. In some embodiments, the device may include a near field communication device for transmitting the input value to an external electronic device. In these embodiments, the input may be used to control the external electronic device. For example, the input value, or series of input values, may be used to open a lock or rotate a document displayed on the external device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects alone or in any combination. Again, the brief summary presented above is intended only to familiarize the reader with certain aspects and contexts of embodiments without limitation to the claimed subject matter.

### BRIEF DESCRIPTION OF THE DRAWINGS

These and other features, aspects, and advantages of the present disclosure will become better understood when the following detailed description of certain exemplary embodiments is read with reference to the accompanying drawings in which like characters represent like parts throughout the drawings, wherein:

FIG. 1 is a front view of an electronic device in accordance with one embodiment;

FIG. 2 is a simplified block diagram of the device of FIG. 1 in accordance with one embodiment;

FIG. 3 is a front view illustrating the device of FIG. 1 with a screen representing a combination lock in accordance with one embodiment;

FIG. 4 is a front view illustrating the device of FIG. 3 after variation of the graphical user interface accordance with one embodiment;

FIG. 5 is a front view illustrating the device of FIG. 1 with an alternate screen representing a combination lock in accordance with one embodiment;

FIG. 6 is a front view illustrating the device of FIG. 1 with a randomized screen portion in accordance with one embodiment;

FIG. 7 is a perspective view of the device of FIG. 1 in communication with an external device in accordance with one embodiment;

FIG. 8 is a flowchart depicting a method for varying a graphical user interface of the electronic device in accordance with one embodiment;

FIG. 9 is a front view illustrating the device of FIG. 1 with an alternate screen in accordance with one embodiment;

FIG. 10 is a perspective view of the device of FIG. 1 in communication with an external device in accordance with one embodiment;

FIG. 11 is an illustration of a system incorporating the device of FIG. 1 in accordance with one embodiment;

FIG. 12 is an illustration of the device of FIG. 1 in operation with the system of FIG. 11 in accordance with one embodiment;

FIG. 13 is a flowchart depicting a method for operating an external device in communication with the device of FIG. 1 in accordance with one embodiment;

FIG. 14 is a flowchart depicting a method for operating the device of FIG. 1 in accordance with one embodiment; and

FIG. 15 is a flowchart depicting a method for programming the device of FIG. 1 in accordance with one embodiment.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to techniques for selecting an input value using a motion sensitive graphical user interface (“GUI”). A motion sensing device, such as an accelerometer, may be used to detect motion and provide motion data to the electronic device. The electronic device may apply the motion data to vary the GUI contemporaneously with the sensed motion. For example, as the electronic device is rotated, a graphical element of the GUI, such as a dial, may be rotated along with the electronic device. In another example, as the electronic device is shaken, a graphical element, such as a die, may be varied to simulate rolling a die. By varying the GUI in response to sensed motion, motion may be used to select inputs for the electronic device and/or an associated device.

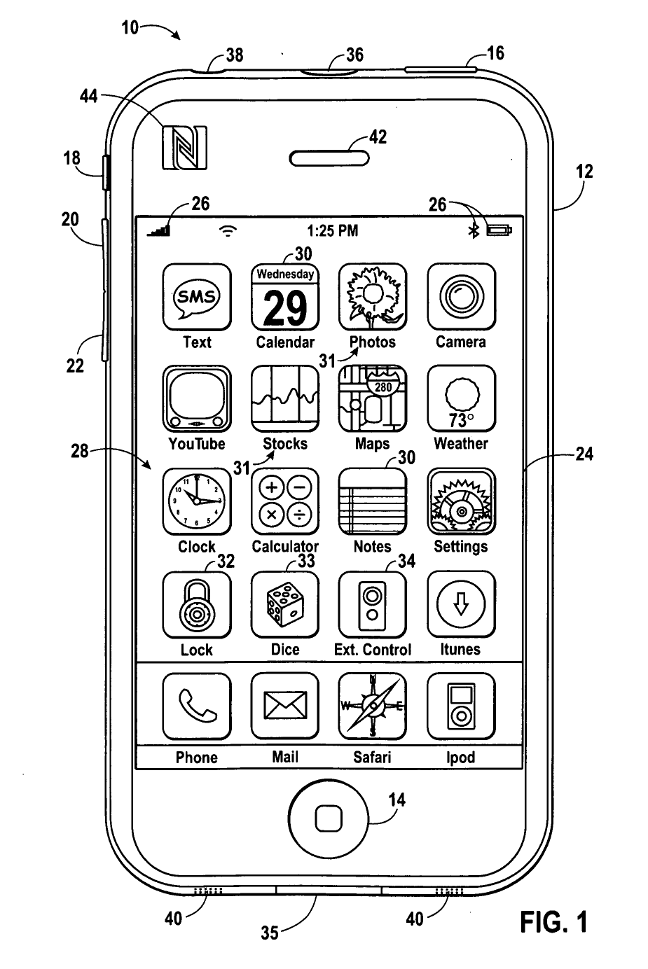

FIG. 1 illustrates an electronic device 10 that may make use of the techniques for a motion sensitive GUI described above. It should be noted that while implementation of the GUI will be described below in reference to the illustrated electronic device 10 (which may be a cellular telephone, a media player for playing music and/or video, a personal data organizer, or any combination thereof), the techniques described herein are usable with any movable device configured to receive input through a GUI.

As illustrated in FIG. 1, the electronic device 10 may be a handheld device incorporating the functionality of one or more portable devices, such as a media player, a cellular phone, a personal data organizer, and so forth. Depending, of course, on the functionalities provided by the electronic device 10, a user may listen to music, play games, record video, take pictures, and place telephone calls, while moving freely with the device 10. In addition, the electronic device 10 may allow a user to connect to and communicate through the Internet or through other networks, such as local or wide area networks. For example, the electronic device 10 may allow a user to communicate using e-mail, text messaging, instant messaging, or other forms of electronic communication. The electronic device 10 also may communicate with other devices using short-range connections, such as Bluetooth and near field communication. By way of example, the electronic device 10 may be a model of an iphone® available from Apple Inc. of Cupertino, Calif.

In the depicted embodiment, the device 10 includes an enclosure 12 that protects the interior components from physical damage and shields them from electromagnetic interference. The enclosure 12 may be formed from any suitable material such as plastic, metal, or a composite material and may allow certain frequencies of electromagnetic radiation to pass through to wireless communication circuitry within the device 10 to facilitate wireless communication.

The enclosure 12 allows access to user input structures 14, 16, 18, 20, and 22 through which a user may interface with the device. Each user input structure 14, 16, 18, 20, and 22 may be configured to control a device function when actuated. For example, the input structure 14 may include a button that when pressed causes a “home” screen or menu to be displayed on the device. The input structure 16 may include a button for toggling the device 10 between a sleep mode and a wake mode. The input structure 18 may include a two-position slider that silences a ringer for the cell phone application. The input structures 20 and 22 may include buttons for increasing and decreasing the volume output of the device 10. In general, the electronic device 10 may include any number of user input structures existing in various forms including buttons, switches, control pads, keys, knobs, scroll wheels, or other suitable forms.

The device 10 also includes a display 24 which may display various images generated by the device. For example, the display 24 may show photos, movies, album art, and/or data, such as text documents, spreadsheets, text messages, and email, among other things. The display 24 also may display system indicators 26 that provide feedback to a user, such as power status, signal strength, call status, external device connection, and the like. The display 24 may be any type of display such as a liquid crystal display (LCD), a light emitting diode (LED) display, an organic light emitting diode (OLED) display, or other suitable display. Additionally, the display 24 may include a touch-sensitive element, such as a touch screen.

The display 24 may be used to display a GUI 28 that allows a user to interact with the device. The GUI 28 may include various layers, windows, screens, templates, elements, or other components that may be displayed in all, or a portion, of the display 24. Generally, the GUI 28 may include graphical elements that represent applications and functions of the device 10. The graphical elements may include icons and other images representing buttons, sliders, menu bars, and the like. In certain embodiments, the user input structure 14 may be used to display a home screen of the GUI 28. For example, in response to actuation of the input structure 14, the device may display graphical elements, shown here as icons 30, of the GUI 28. The icons 30 may correspond to various applications of the device 10 that may open upon selection of an icon 30. The icons 30 may be selected via a touch screen included in the display 24, or may be selected by user input structures, such as a wheel or button.

The icons 30 may represent various layers, windows, screens, templates, elements, or other components that may be displayed in some or all of the areas of the display 24 upon selection by the user. Furthermore, selection of an icon 30 may lead to a hierarchical navigation process, such that selection of an icon 30 leads to a screen that includes one or more additional icons or other GUI elements. Textual indicators 31 may be displayed on or near the icons 30 to facilitate user interpretation of each icon 30. It should be appreciated that the GUI 30 may include various components arranged in hierarchical and/or non-hierarchical structures.

When an icon 30 is selected, the device 10 may be configured to open an application associated with that icon and display a corresponding screen. For example, when the lock icon 32 is selected, the device 10 may be configured to open a combination lock application and display a screen for entering a combination lock code. When the dice icon 33 is selected, the device 10 may be configured to open a dice application and display a screen with a user interface that simulates rolling a die. When the external control icon 34 is selected, the device 10 may be configured to open an application that allows a user to manipulate an external device using the electronic device 10. For example, a user may be able to rotate an image displayed on the external device by rotating the device 10. For each application, screens may be displayed on the display 24 that include various GUI elements.

The electronic device 10 also may include various input and output (I/O) ports 35, 36, and 38 that allow connection of the device 10 to external devices. The input/output port 35 may be a connection port for transmitting and receiving data files, such as media files. For example, the I/O port 35 may be a proprietary port from Apple Inc. The I/O port 36 may be a connection slot for receiving a subscriber identify module (SIM) card. The I/O port 38 may be a headphone jack for connecting audio headphones. In other embodiments, the device 10 may include any number of I/O ports configured to connect to a variety of external devices, including but not limited to a power source, a printer, and a computer. In other embodiments, multiple ports may be included on a device. The ports may be any interface type, such as a universal serial bus (USB) port, serial connection port, Firewire port, IEEE-1394 port, or AC/DC power connection port.

The electronic device 10 may also include various audio input and output structures 40 and 42. For example, the audio input structures 40 may include one or more microphones for receiving voice data from a user. The audio output structures 42 may include one or more speakers for outputting audio data, such as data received by the device 10 over a cellular network. Together, the audio input and output structures 40 and 42 may operate to provide telephone functionality. Further, in some embodiments, the audio input structures 40 may include one or more integrated speakers serving as audio output structures for audio data stored on the device 10. For example, the integrated speakers may be used to play music stored in the device 10.

The device 10 may further include a near field communication (NFC) interface 44. The NFC interface 44 may be located within the enclosure 12, and a mark or symbol on the exterior of the enclosure 12 may identify its location within the enclosure 12. The NFC interface 44 may allow for close range communication at relatively low data rates (424 kb/s), and may comply with standards such as ISO 18092 or ISO 21481. In certain embodiments, the communication may occur within a range of approximately 2 to 4 cm. The close range communication with the NFC interface 44 may take place via magnetic field induction, allowing the NFC interface 44 to communicate with other NFC interfaces or to retrieve information from tags having radio frequency identification (RFID) circuitry. As discussed below, the NFC interface 44 may provide a manner of initiating control of external devices using the device 10.

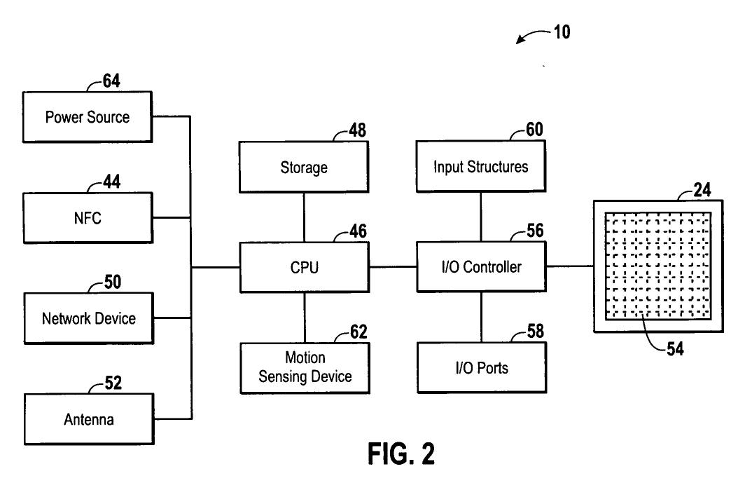

Additional details of the illustrative device 10 may be better understood through reference to FIG. 2, which is a block diagram illustrating various components and features of the device 10 in accordance with one embodiment of the present invention. The block diagram includes the display 24 and the NFC interface 44 discussed above, as well as many other components.

The operation of the device 10 may be controlled by a central processing unit (CPU) 46 that provides the processing capability required to execute the operating system, programs, GUI 28, and any other functions of the device 10. The CPU 46 may include a single processor or it may include a plurality of processors. For example, the CPU 46 may include “general purpose” microprocessors, a combination of general and special purpose microprocessors, instruction set processors, graphics processors, video processors, and/or related chips sets, and/or special purpose microprocessors. The CPU 46 also may include on board memory for caching purposes.

Information used by the CPU 46 may be located within long-term storage 48. The long-term storage 48 of electronic device 10 may be used for storing data required for the operation of the CPU 46 as well as other data required by the device 10. For example, the storage 48 may store the firmware for the electronic device 10 that is used by the CPU 46. The firmware may include an operating system, as well as other programs that enable various functions of the electronic device 10, GUI functions, and/or processor functions. The storage 48 also may store components for the GUI 28, such as graphical elements, screens, and templates. Additionally, the long term storage 48 may store data files such as media (e.g., music and video files), image data, software, preference information (e.g., media playback preferences), wireless connection information (e.g., information that may enable the device 10 to establish a wireless connection, such as a telephone connection), subscription information (e.g., information that maintains a record of podcasts, television shows or other media to which a user subscribes), telephone information (e.g., telephone numbers), and any other suitable data. The long term storage 48 may be non-volatile memory such as read only memory, flash memory, a hard drive, or any other suitable optical, magnetic, or solid-state computer readable media, as well as a combination thereof.

One or more network devices 50 may provide additional connectivity channels for receiving and transmitting information. The network device 50 may represent, for example, one or more network interface cards (NIC) or a network controller. The network device 50 may include a local area network (LAN) interface for connecting to a wired Ethernet-based network and/or a wireless LAN, such as an IEEE 802.11x wireless network. In certain embodiments, the NFC interface 44 may be used to receive information, such as the service set identifier (SSID), channel, and encryption key, used to connect to the LAN.

The network device 50 also may include a wide area network (WAN) interface that permits connection to the Internet via a cellular data network, such as the Enhanced Data rates for GMS Evolution (EDGE) network or the 3G network. The network device 50 may coordinate with one or more antennas 52 to transmit and receive radio frequency signals of a cellular network. Further, the network device 50 may include a personal area network (PAN) interface for connecting to a Bluetooth® network, an IEE 802.15.4 (ZigBee) network, or an ultra wideband network (UWB). The network device 50 may include any number and combination of network interfaces. As will be appreciated, the network device may employ one or more protocols, such as the High-Speed Downlink Packet Access (HSDPA) protocol, for rapidly downloading data over a network. Additionally, the network device 50 may allow the device 10 to receive a software upgrade that enables the device 10 to receive motion based inputs in accordance with certain embodiments.

In certain embodiments, the device 10 may use a device identification networking protocol to establish a connection with an external device through a network interface. For example, both the device 10 and the external device may broadcast identification information using internet protocol (IP). The devices may then use the identification information to establish a network connection, such as a PAN connection or a LAN connection, between the devices. By way of example, the device identification protocol may be Bonjour® by Apple Inc.

Information received through the network device 50, as well as information contained in the storage 48, may be displayed on the display 24. As noted above, a user may select information to display through the GUI 28 (FIG. 1). A touch screen 54 may be positioned in front of or behind the display 24 and may be used to select graphical elements, such as the icons 30 (FIG. 1), shown on the display 24. The touch screen 54 is configured to receive input from a user's or object's touch and to send the information to the CPU 46, which interprets the touch event and performs a corresponding action. The touch screen 54 may employ any suitable type of touch screen technology such as resistive, capacitive, infrared, surface acoustic wave, electromagnetic, or near field imaging. Furthermore, the touch screen 54 may employ single point or multipoint sensing.

An input/output (I/O) controller 56 may provide the infrastructure for exchanging data between the CPU 46 and input/output devices, such as the touch screen 54 and the display 24. The I/O controller 38 may contain one or more integrated circuits and may be integrated with the CPU 46 or exist as a separate component. The I/O controller 56 also may provide the infrastructure for communicating with external devices through the I/O ports 58. The I/O ports 58 may include the I/O ports 34, 36, and 38 shown in FIG. 1 and may be used for connecting the device 10 to an external computer, a printer, audio headphones, or the like.

As noted above, a user may navigate through the GUI 28 (FIG. 1) using the input structures 60 located on external surfaces of the device 10. The user input structures 60 may include the input structures 14, 16, 18, 20, and 22 shown in FIG. 1 and may communicate with the CPU 46 through the I/O controller 56. The user input structures 60 may be used in conjunction with, or independently of, the touch screen 54 to select inputs for the device 10.

In addition to receiving user input through the input structures 60 and the touch screen 54, the device 10 may include a motion sensing device 62 for receiving user input. The motion sensing device 62 may be any device configured to measure motion or acceleration, such as an accelerometer or a gyroscope. In one embodiment, the motion sensing device 40 may be a three-axis accelerometer that includes a sensing element and an integrated circuit interface for providing the measured acceleration and/or motion data to the CPU 46. The motion sensing device 62 may be configured to sense and measure various types of motion including, but not limited to, velocity, acceleration, rotation, and direction.

Input from the motion sensing device 62 may be used to facilitate selection of inputs for the device 10. As discussed further below, the motion sensing device 62 may be configured to sense motion of the device 10 and transmit motion data to the CPU 46 to adjust graphical elements shown on the display 24. For example, a graphical element, such as a dial, may be rotated on the display 24 in response to sensed motion. As the dial rotates, various values disposed around the dial may be identified as an input value. In certain embodiments, the inputs selected using the motion sensing device 40 may be transmitted to an external device through the NFC interface 44 or the network device 50 to facilitate control of the external device.

The portability of the device 10 makes it particularly well suited to motion-based input selection. To facilitate transport and ease of motion, the device 10 may include an integrated power source 64 for powering the device 10. The power source 64 may include one or more batteries, such as a Li-Ion battery, which may be user-removable or secured to the enclosure 12. In certain embodiments, the proprietary connection I/O port 34 may be used to connect the device 10 to a power source for recharging the battery.

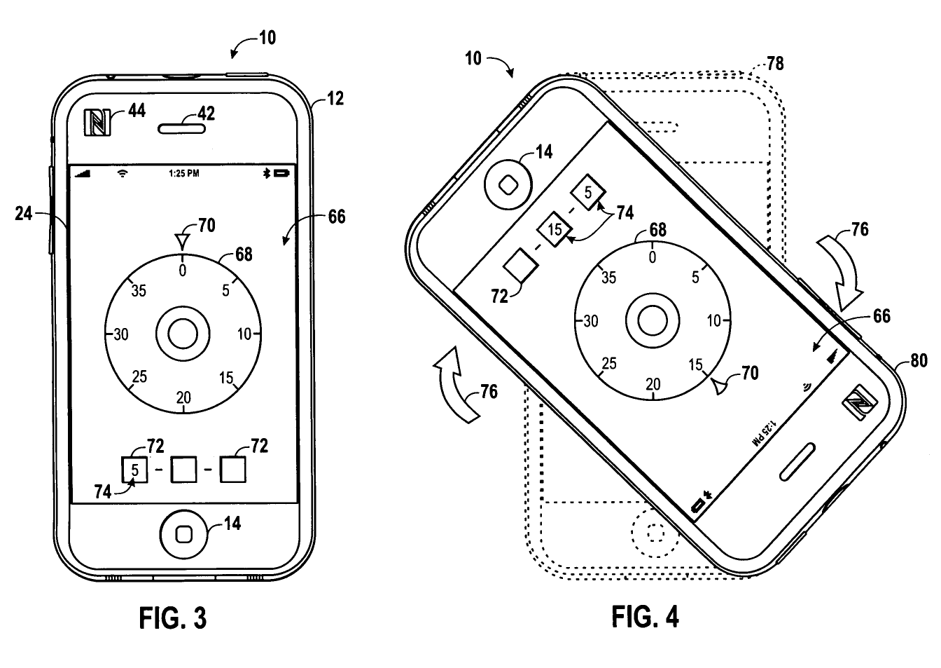

FIG. 3 illustrates the device 10 with a screen 66 for receiving a motion-based input in accordance with one embodiment. The device 10 may be configured to display the screen 66 on the display 24 in response to user selection of the lock icon 32 (FIG. 1). As noted above, the lock icon 32 may be selected using the touch screen 54 (FIG. 2), an input structure 60 (FIG. 2), or a combination thereof. The screen 66 includes several graphical elements of the GUI 28, including a dial 68 and a pointer 70 disposed near the dial 68. The dial 68 and the pointer 70 together are intended to function as an interface for entering a code for a combination lock. The dial 68 includes several numbers (e.g., numbers 0, 5, 10, etc.) that may be aligned with the pointer 70 to select one of the numbers. As the device 10 is rotated, the dial 68 may remain in a fixed position relative to a user while the pointer 70 rotates around the dial contemporaneously with the rotation of the device 10.

The screen 66 may be included within the GUI 28 and may be stored within the long-term storage 48 of the device 10. Further, in some embodiments, the screen 66 may be generated dynamically in response to motion of the device. The screen 66 includes three display areas 72 disposed along the bottom of the screen for displaying indications 74. The indications 74 may represent inputs selected by rotating the device to align the pointer 70 with numbers on the dial 68. For example, a user may rotate the device 10 to align the pointer 70 with a number, and then select that number as an input to display it as an indication 74 in one of the display areas 72. Each selected number may be displayed as an indication 74 upon its selection, allowing a user to identify previously selected numbers. As shown in FIG. 3, the first display area 72 contains the number five, indicating that the number 5 has been selected as the first input. Of course, the number of display areas 72 may vary depending on the number of inputs required. Further, the display areas 72 may be of different shapes and/or sizes, may be located in different areas of the screen 66, or may not be included in the screen 66 at all.

Once the pointer 70 is aligned with a number on the dial 68, the number may be selected to enter that number as an input for the lock combination. For example, the input structure 14 may be configured to select the aligned number when pressed by a user, or the touch screen may be configured to receive a touch that selects the aligned number. In certain embodiments, various other selection mechanisms may be used, such as specific motions of the device 10. For example, the device 10 may be configured to select an aligned number upon sensing a downward motion of the device 10. In this manner, a user may tilt the top portion of the device 10 toward the ground to select the aligned value.

FIG. 4 depicts the screen 66 after rotation of the device 10. As shown, the device 10 has been rotated to the right, as generally indicated by arrows 76, from its original position 78 to a new position 80. This change in position may be caused by a user's physical manipulation of the device 10. For example, a user may hold the device 10 and rotate the device 10 in the direction shown by the arrows 76. In another example, a user may place the device 10 on a flat surface, such as a table, and spin the device 10 in the direction shown by the arrows 76.

As shown in FIG. 4, although the device 10 has rotated to a new position 80, the dial 68 has stayed in relatively the same position from the perspective of the user. However, the pointer 70 has rotated with the device. This is best illustrated by comparing FIGS. 3 and 4. In FIG. 3, the dial 68 is aligned with the pointer 70 at the number 0. After the rotation shown in FIG. 4, the pointer 70 is aligned with the dial 68 at the number 15. In short, the dial 68 has remained in the same position with respect to the user while the pointer 70 has rotated around the dial 68 in accordance with the rotation of the device 10.

The second display area 72 contains an indication 74, indicating that the number 15 has been selected by the user as the second input. As noted above, the selection may have been performed using an input structure, such as structure 14, or by moving the device 10 in a specific manner. It should be noted that the indications 74 have also rotated with the device 10 to be readable from the user's perspective. However, in other embodiments, the indications 74 may remain in fixed positions with respect to the motion of the device 10.

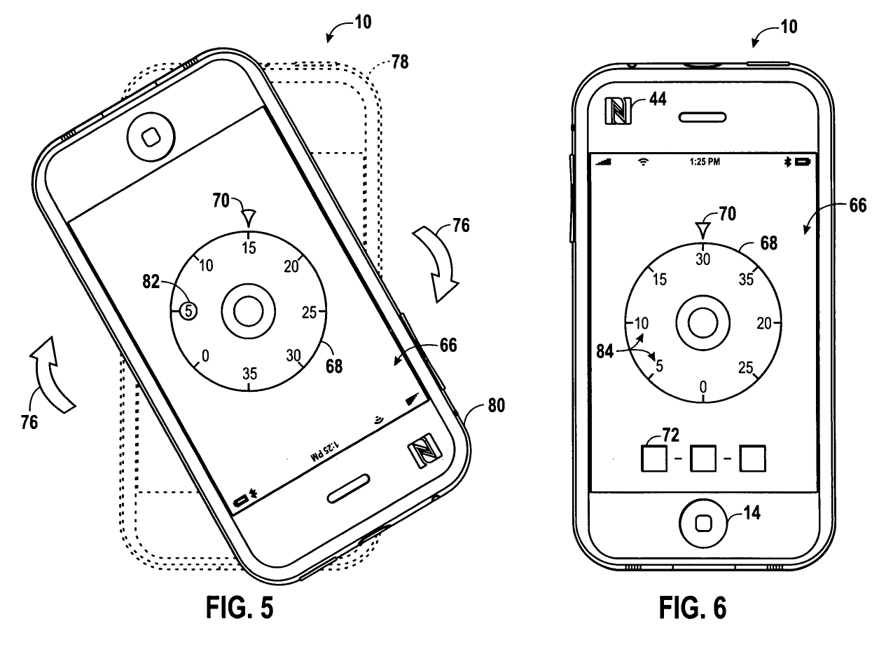

FIG. 5 illustrates an alternate embodiment of the device 10 displaying the screen 66. Again, the screen 66 includes the dial 68 and the pointer 70. However, in this embodiment, the pointer 70 has remained stationary relative to the user while the dial 68 has rotated along with the device 10 from the original position 78 to the new position 80. Further, the display areas have been omitted, and an indication 82 showing the previously selected input is displayed on the dial 68 itself. Specifically, as shown, the indication 82 indicates that the number 5 has been previously selected as the first input. The indication 82 may take on various shapes, sizes, and colors to indicate the first, second, and third input values received. For example, a blue circle may indicate the first input, a red square may indicate the second input, and a yellow triangle may indicate the third input. In another example, the indication 82 may appear as a superscript or superscript next to the input value to specify whether the input is the first, second, or third input.

FIG. 6 illustrates another embodiment of the screen 66. Again, the screen includes the dial 68 and the pointer 70. However, the dial numbers may represent configurable labels 84 that may be generated by the device 10. In this embodiment, the labels 84 include numbers placed on the dial 68 in a random order. The random order may be generated by circuitry within the CPU 46 and may be communicated to the display 14 through the I/O controller 56. The device 10 may be configured to generate a random order for the labels 84 in response to user selection of the lock icon 32 (FIG. 1), or a user may be able to designate the randomization process through user preferences stored in the long-term storage 48. As shown in FIG. 6, the display areas 72 are located along the bottom of the screen 66. However, in other embodiments, the display areas 72 may not be included or may be located on the dial itself as shown in FIG. 5. The randomized order of the labels 84 may enhance the security of the device 10. For example, the randomized order may ensure that the user's physical movements while entering the combination vary during different combination entries. Thus, even though the same combination may be entered, different motions may be used, making the motions relatively unrecognizable and/or unintelligible to an observer.

The labels 84 may include images, colors, text, or combinations thereof instead or, or in addition to numbers. For example, the labels 84 may correspond to colors to simulate a spinner that may be used for a board game. The labels 84 may be stored as part of the GUI 28 within the device 10. Further, in some embodiments, the labels 84 may be configurable by a user. In one example, a child may enter the names of his friends using a touch sensitive virtual keyboard included within the GUI 28 to display the names on the dial 68. The child may then spin the device 10 to select one of his friends to take a turn during a game, such as hopscotch or four square. In another example, a user may designate photos or images stored within the device 10 to be used as the labels 84. In some embodiments, the images may be used as input values for a combination lock.

As will be appreciated, the motion-based input techniques described herein may find application in a variety of areas. As shown in FIGS. 3-6, the techniques may be used to simulate opening a combination lock. In certain embodiments, the input values selected by aligning the pointer 70 may include directional motion data, in addition to the value selected. For example, the input values may include the direction of rotation, such as whether the device was turned in a clockwise or counter clockwise motion. The input values also may include motion data describing how far the device was rotated. These embodiments may more closely simulate opening a physical combination lock, which generally requires a first input in the clockwise direction, a second input in the counterclockwise direction with a full rotation, and a third input in the clockwise direction. Further, the motion-based techniques are not intended to be limited to entry of inputs for a lock combination. For example, motion-based inputs may be used to enter a pin code or randomly select an item from a list.

The motion-based input techniques also may be used to simulate rolling a die, such as the type used in a board game. For example, the dial 68 and the pointer 70 may be replaced by a graphical element representing a six-sided die. The graphical element may vary contemporaneously with motion of the device 10 to simulate rolling a die. For example, different sides of the die may be displayed depending on the direction and amount of motion. The displayed side of the die may then be selected to enter the displayed value as an input. The die simulation application may be accessed by selecting the icon 33 shown in FIG. 1, and may be particularly useful in unsteady environments, such as a plane or subway.

The motion-based inputs may be applied to various device applications. For example, the device 10 may include an electronic lock application that restricts access to the device 10 (or to certain device applications) until the correct combination has been entered. The combination may be entered using the techniques described with respect to FIGS. 3-6. If the combination matches a combination stored within the storage 48 of the device 10, the device 10 may be configured to allow access to the device 10. If the combination does not match, the device 10 may be configured to remain locked. In another example, the device 10 may include an electronic game, such as Yahtzee® that a user may play to pass the time. The die simulation application may be used to provide motion-based inputs representing rolls of a die to the electronic game. Furthermore, the inputs may be used to perform functions and/or control an external device. For example, a combination generated using motion-based inputs may be transmitted to an external device to unlock the external device.

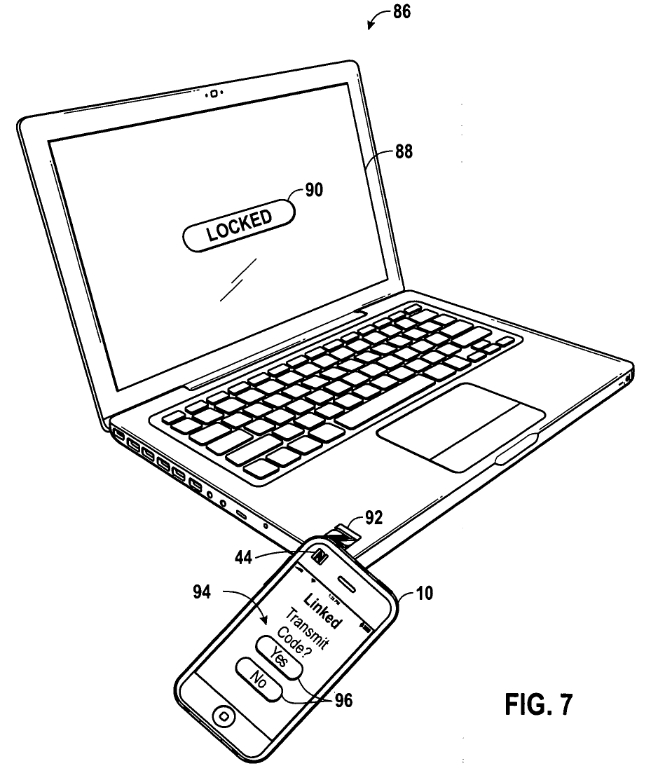

FIG. 7 illustrates the device 10 in communication with an external device 86 to open a lock. Although the external device 86 is shown here as a computer, the external device 86 may be any suitable electronic device, such as a portable media player, personal data assistant, or electronic lock that may be used to access a door, car, house, or other physical area. The external device 86 may include a display 88 that shows an indication 90 indicating that the external device 86 is locked. However, in other embodiments, the display 88 may be omitted.

After a user has entered the combination into the electronic device 10, for example, using the motion-based GUI described above with respect to FIGS. 3-6, the electronic device 10 may be positioned near the external device 86 to transmit the combination to the external device 86. The external device 86 may include an NFC interface 92 allowing near field communication with the electronic device 10. When the NFC interface 44 of the electronic device 10 is brought within a close range, such as 2 to 4 centimeters, of the NFC interface 92 of the external device 86, communication may occur between the electronic device 10 and the external device 86. Either device 86 or 10 may be configured to initiate the near field communication. Furthermore, either device 86 or 10 may operate in active or passive mode or both devices may operate in active mode.

In a presently contemplated embodiment, the device 10 may exist in a passive mode to reduce the power consumption of the device 10. The external device 86 may exist in an active mode, generating a radio field and periodically emitting a ping message to find devices within its range. In response to receiving a ping message, the device 10 may transmit an acknowledgement message. The acknowledgement message, as well as subsequent communications, may occur while the device 10 is in passive mode by using load modulation to transfer data between the devices 10 and 86. However, in other embodiments, the device 10 may enter an active mode in response to the ping message and generate its own radio field for transferring data between the devices 10 and 86. As will be appreciated, in other embodiments, the external device 86 may remain in a passive mode while the electronic device 10 initiates communication while in an active mode. In these embodiments, the device 10 may be configured to enter the active mode in response to a user input, such as selection of the lock icon 32 shown in FIG. 1.

Referring again to FIG. 7, when communication has been established between the electronic device 10 and the external device 86, the electronic device 10 may display a screen 94 indicating that the devices 10 and 86 are linked by a communication link, such as a near field communication channel. The screen 94 may include graphical elements 96 that prompt the user to initiate transmission of the combination to the external device 86. The graphical elements 96 may be icons selectable by the user through the touch screen 54 (FIG. 2) or the input structure 14 (FIG. 1). In response to a user input, the device 10 may transmit the combination to the external device 86 using the near field communication channel. The external device 86 may then compare the received combination to a stored combination, and unlock the external device 86 if the received combination matches the stored combination. In other embodiments, the device 10 may be configured to automatically transmit the combination to the external device 86 when a communication link has been established.

Various types of security measure may be employed during communication of the devices 10 and 86. For example, the electronic device 10 may encrypt the combination prior to transmission to the external device 86. The external device 86 may include a previously received key for decrypting the combination. The external device 86 also may be configured to detect identification information for the electronic device 10 through the near field communication link. For example, the external device 86 may require the combination to be transmitted from a device 10 having a specific serial number, cellular telephone number, or the like. The correct combination and the correct identification number both may be required to unlock the external device 86.

As will be appreciated, the communication link between the device 10 and 86 may include various types of communication links, such as a local area network (LAN) connection, a personal area network (PAN), or a wired data connection, instead of, or in addition to, a near field communication link. In some embodiments, a near field communication link may be used to initiate the communication and to exchange parameters for communicating using a wireless network connection. Further, other types of cryptographic protocols such as Transport Layer Security (TLS) and Secure Sockets Layer (SSL) may be used to provide secure communication between the devices 10 and 86.

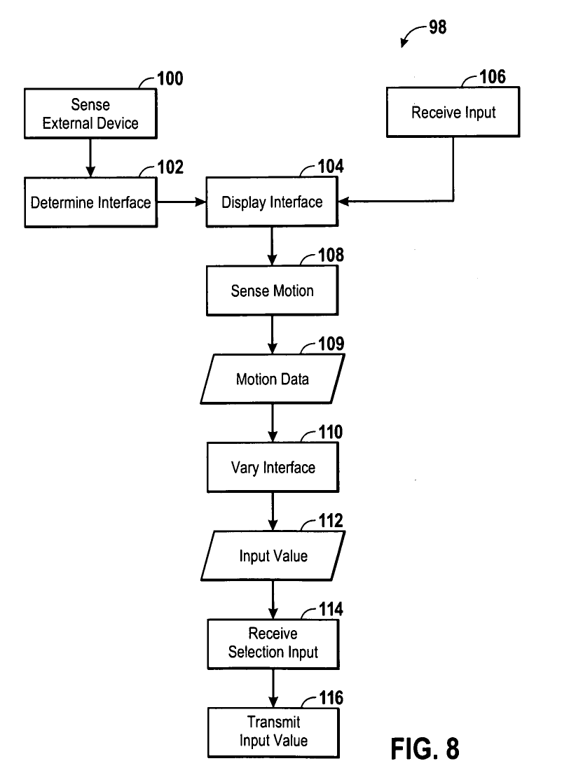

Referring now to FIG. 8, a flow chart is depicted of an exemplary method 98 for producing a motion-based input. This method 98 may be employed to produce various types of inputs, including but not limited to a code for a combination lock, a pin number, a number representing the roll of a die, and a randomly selected color.

The method 98 may begin in one of two ways. First, the method 98 may begin by sensing (block 100) an external device. For example, the NFC interface 44 (FIG. 7) of the electronic device 10 may sense the external device 86 (FIG. 7) when the two devices 10 and 86 are brought within close proximity to each other. Upon sensing the external device, the electronic device may determine (block 102) an interface to display on the device. The interface may be a collection of screens, templates, and graphical elements included within the GUI 28 (FIG. 1).

The external device may be associated with a particular interface stored in the storage 48 (FIG. 2) of the electronic device 10. For example, the serial number of a computer may be associated with an interface for entering a three-digit lock code, such as the interface shown in FIGS. 3-6. The interface determination also may depend on the state of the external device. For example, when the external device 86 is in a locked mode, as shown in FIG. 7, the external device 86 may transmit a signal to the electronic device 10 indicating the locked state. Upon sensing the signal, the electronic device 10 may be configured to display the interface including the screen 66 for receiving motion-based inputs to open the lock. In another example, if the external device has a game application open, the electronic device 10 may be configured to detect the open application and display an interface for rolling a die. The state of the external device may be determined using the techniques described in U.S. Patent Application No. 61/059804 to Michael Rosenblatt et al., filed on Jun. 8, 2008, incorporated herein by reference in its entirety for all purposes. Further, tables and/or tangible machine-readable code may be included within the device 10 to determine the appropriate interface.

The method 98 also may begin by receiving (block 106) a user input. For example, referring to FIG. 1, a user may select a graphical element 32, 33, or 34 shown on the display 24 using the touch screen 54 (FIG. 2) or an input structure 60 (FIG. 2). The electronic device 10 may be configured to display an interface corresponding to the graphical element selected. For example, in response to selection of the lock icon 32 is selected, the device 10 may display a lock interface as shown in FIG. 3. In another example, in response to selection of the die icon 36, the device 10 may be configured to display an interface for rolling a die.

The method 98 continues by displaying (block 104) the determined interface on the electronic device 10. As noted above, the interface may include, among other things, a screen for entering a combination lock code or a personal identification number, or a screen for simulating rolling a die or spinning a spinner. The device 10 may then sense (block 108) motion. For example, as a user rotates the electronic device 10, the motion sensing device 62 (FIG. 2) may sense the motion and produce motion data 109 corresponding to the motion. In one embodiment, an accelerometer may sense motion along one, two, or three axis to produce the motion data 109. The motion data 109 may include various types of motion data such as acceleration, velocity, distance, and direction.

Contemporaneously to sensing motion (block 108), the method 98 may include varying (block 110) the interface. In one embodiment, the varying of the interface may include moving one graphical element of the interface in accordance with the motion of the device while another graphical element remains in a fixed position with respect to the user. In another embodiment, the varying of the interface may include rotating the view of a graphical element, such as a die, on the display to show different sides of the graphical element. Each side of the graphical element may correspond to a different input value.

As the interface is varied, input values 112 are identified. In one embodiment, graphical elements may be aligned to identify the input values. For example, referring to FIG. 4, as the electronic device 10 is rotated to the right as indicated by the arrows 76, the pointer 70 may rotate in a clockwise direction to align first with the number 5, then with the number 10, and finally with the number 15 when the device 10 has stopped moving. During this rotation, each of the numbers 5, 10, and 15 may be consecutively identified as input values. In another embodiment, different views of a graphical element may be displayed to identify the input values. For example, the graphical element may include a six-sided die with each side corresponding to an input value.

An indication may be displayed on the device to identify the current input value. For example, as shown in FIG. 4, the pointer 70 identifies the current input value as 15, and the number 15 appears as an indication 74 in the second display area 72. Various types of indications may be used to identify the input value, such as colors, highlighting, textual displays, and selection boxes.

After the input value is identified, the method continues by receiving (block 114) a selection input. The selection input may be entered by a user via the touch screen 54 (FIG. 2) or an input structure 60 (FIG. 2) of the device 10. For example, a user may contact an area of the touch screen 54 near an indication to select the corresponding value as the input value. In another example, a user may actuate an input structure 60 (FIG. 2) while an input value is displayed as an indication to select that value. In other embodiments, the selection input may be entered using motion of the device. For example, the device 10 may be configured to recognize a downward motion as a selection input. While an input value is displayed as an indication, a user may tap the device toward the ground to select that value as the input value.

Once the input value has been selected, the device 10 transmits (block 116) the input value. In some embodiments, the input value may be transmitted within the electronic device itself. For example, the input value may be transmitted to a lock application to allow a user to access the electronic device. In another example, the input value may transmitted to a game application currently in use on the electronic device. In other embodiments, the input value may be transmitted to an external device, such as external device 86 shown in FIG. 7. The input value may be used to perform a function on the external device, such as unlocking the external device, or rotating an image displayed on the external device.

Of course, certain interfaces may require multiple input values. For example, a combination lock interface may require three input values with corresponding motion data indicating the direction and amount of rotation. In these embodiments, the method 98 may include storing the input values until all of the input values have been received. The input values may then be transmitted as a set.

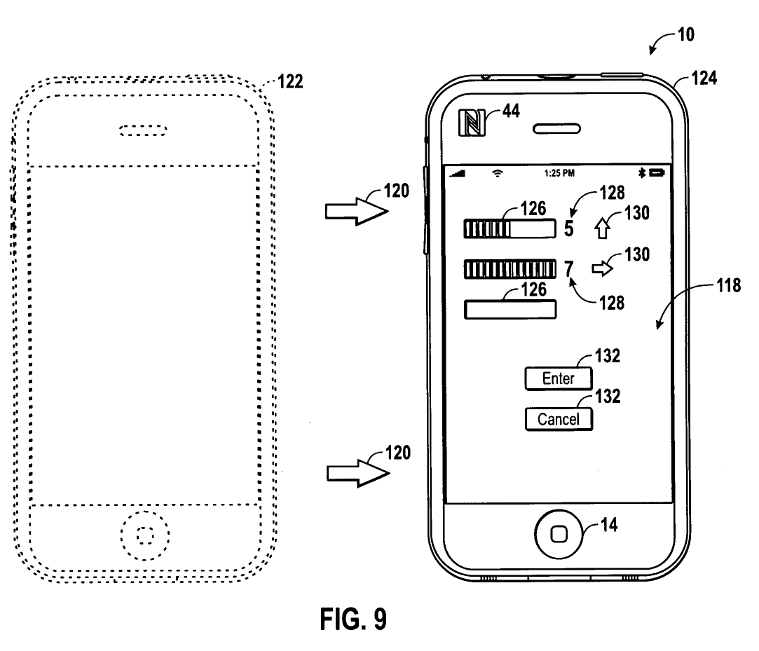

FIG. 9 illustrates an alternate screen 118 for receiving a motion-based input. The screen 118 includes three types of graphical elements 126, 128, and 130 that serve as motion indicators. The status bars 126 display a graphical representation of the velocity, the indicators 128 display a value corresponding to the distance, and the indicators 120 display arrows indicating the direction of motion. The multiple sets of indicators 126, 128, and 130 allow each input to be based on multiple properties of the motion. Thus, each input may include a set of input values based on different motion properties. As shown, each input includes three specific properties, velocity, distance, and direction, that may be represented by motion data. The multiple properties associated with each input may provide an enhanced level of security for applications such as an electronic lock. Of course, in other embodiments, any number of properties may be associated with each input.

As shown, the device 10 has moved, as indicated by arrows 120, from its original position 122 to a new position 124. The indicators 126, 128, and 130 display the motion properties contemporaneously as the device 10 moves. As described above with respect to FIG. 8, the displayed motion properties may be selected by a user to set the properties as input values. The screen 118 includes prompts 132 that may be selected to either select or cancel the displayed input values. The first set of input values shown on the screen 118 have been previously selected by the user to have a medium velocity as shown by the status bar 126, a distance of five as shown by the indicator 128, and an upward direction as shown by the indicator 130. In one embodiment, these input values may have been identified by extending the device away from the user for approximately five inches at a medium velocity. Once displayed, the input values may have then been selected using the enter prompt 132.

The second set of input values shown on the screen 118 are currently displayed on the screen 118 for selection. As displayed, the second set of inputs include a high velocity as shown by the status bar 126, a distance of seven as shown by the indicator 128, and a right direction as shown by the indicator 130. In one embodiment, the input values may have been identified by moving the device to the right by approximately seven inches at a high velocity. The input values may be selected using the enter prompt 132. In one embodiment, the user may contact the touch screen 54 (FIG. 2) near the enter prompt to select the input values. The user also may cancel the values via the cancel prompt 132. In response to selection of the cancel prompt, the input values may be cleared from the screen 118 so that new input values may be identified. Upon entry of the second set of input values, a user may move the device a third time to identify the third set of input values. As shown, the third status bar 126 is empty, indicating that the third set of input values has not yet been identified.

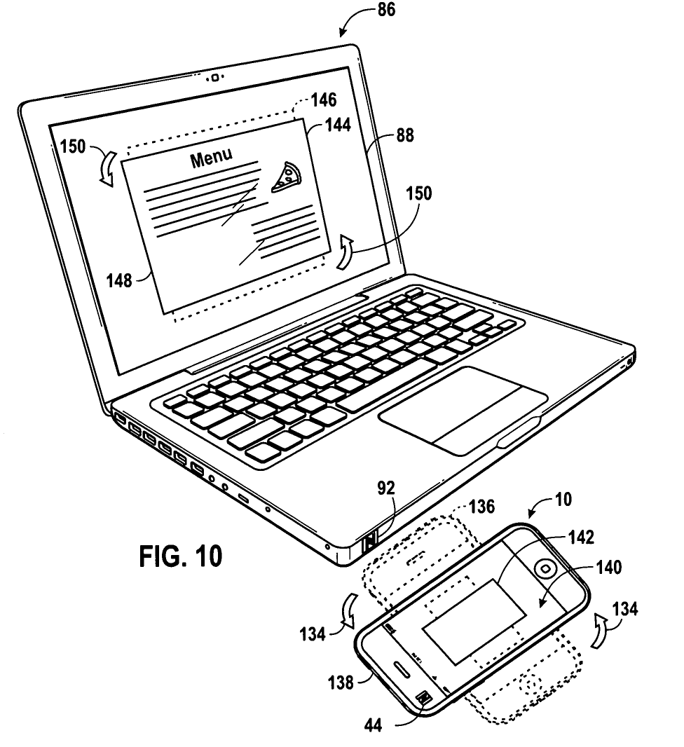

Referring again to FIG. 7, the motion-based inputs may be, transmitted to an external device 86 to unlock the external device 86. However, as noted above, the motion-based inputs are not intended to be limited to lock applications and may be used to perform various functions of an external device 86. Accordingly, FIG. 10 illustrates another embodiment of the electronic device 10 for using a motion-based input to control the display of a document on the external device 86.

As shown in FIG. 10, the device 10 may communicate with the external device 86 using a near field communication channel established by bringing the near field communication interfaces 44 and 92 within a close range of each other. In some embodiments, the near field communication channel may be used for all communications between the device 10 and the external device 86. However, in other embodiments, the near field communication channel may be used only initially to setup another communication link, such as a LAN or PAN link. In yet other embodiments, the devices 10 and 86 may communicate solely using another communication link, such as a LAN or PAN link.

As shown, the device 10 has been rotated to the left, as indicated by the arrows 134, from its original position 136 to a new position 138. A screen 140 of the GUI 28 is displayed on the device 10 to facilitate control of the external device 86. The screen 140 may be displayed in response to selection of the external control icon 34 (FIG. 1), or it may be displayed automatically upon establishment of the near field communication channel. The screen 140 includes a graphical element 142 depicting a document. The graphical element 142 may represent a corresponding document 144, shown here as a menu for a pizza restaurant, displayed on the external device display 88.

The external device 86 may be configured to rotate the document 144 contemporaneously with the rotation of the device 10. As shown on the external device display 88, the document 144 has been rotated in a manner corresponding to the rotation of the device 10. Specifically, the document 144 has been rotated to the left from its original position 146 to a new position 144, as indicated by arrows 150. As the device 10 is rotated, the device 10 may send motion data through the near field communication channel to the external device 86. Control circuitry of the external device 86 may then interpret the motion data and rotate the displayed document 144 contemporaneously with receiving the motion data. In certain embodiments, the screen 140 may not be present, and the rotation of the device 10 may be performed without using the display of the device 10. However, in other embodiments, the screen 140 may display the graphical element 142 to assist the user in controlling the external document 144. The document rotation techniques may allow the user to rotate documents and images such as maps, menus, photographs, and the like.

In certain embodiments, the motion data sensed by the device 10 may be transmitted over a network connection established between the external device 86 and the electronic device 10. The NFC communication link may be used to establish the connection, and then once established, the device 10 may be moved further from the external device 86. This may allow external control from a longer distance.

The method for external device control may be executed as shown in FIG. 8. Again, the method 98 may begin by either sensing (block 100) the external device 86 or by receiving (block 106) input from the user. In some embodiments, the electronic device 10 may receive information from the external device 86 and use it to determine (block 182) the interface to display on the device 10. For example, the electronic device 10 may detect an open word processing application on the external device 86 (FIG. 7) and accordingly display the screen 140 (FIG. 7) to facilitate external document control. In other embodiments, the screen 140 may be displayed in response to a user's selection of the external control icon 34 (FIG. 1).

The method continues by sensing (block 108) motion to produce motion data 109. The device 10 may use the motion data 109 to vary the interface. For example, as shown in FIG. 10, the graphical element 142 may be rotated along with the device 10, while dashed lines depict the original location of the graphical element 142. The dashed lines may facilitate user identification of the original document position. The motion data 109 may be used to determine the new location and the original location displayed on the device 10. Further, the motion data may be used to determine an input value 112. The input value 112 may include the rotation amount and direction and may be displayed on the device 10 as an indication. For example, as shown in FIG. 10, the device 10 has been rotated approximately ninety degrees to the left. Text and/or graphics representing the ninety-degree rotation may be displayed on the screen. A user may then select the rotation amount using the touch screen or an input structure. In response to receiving (block 114) the selection, the device may transmit (block 116) the input value 112 to the external device 86 to rotate the document 144.

In other embodiments, the device 10 may not display an interface to facilitate the document rotation. In these embodiments, the display 88 of the external device 86 may serve as the interface. For example, as shown in FIG. 10, the screen 140 may not be present. Instead, as the device 10 is rotated, the displayed document 144 may be rotated on the display 88. Referring again to FIG. 8, steps 102, 104, 110, and 114 may be omitted in these embodiments. The method may begin by sensing (block 100) an external device or by receiving (block 106) a user input. The device 10 may then sense (block 108) motion to produce motion data 109. The motion data 109 may be used to determine an input value 112, which may represent, for example, the amount and direction of rotation of the device. The input value 112 may then be transmitted (block 116) to the external device to rotate the document 144 (FIG. 10) in a manner corresponding to the input value 112. These steps may occur in a rapid succession so that the document 144 appears to rotate simultaneously with the rotation of the device 10.

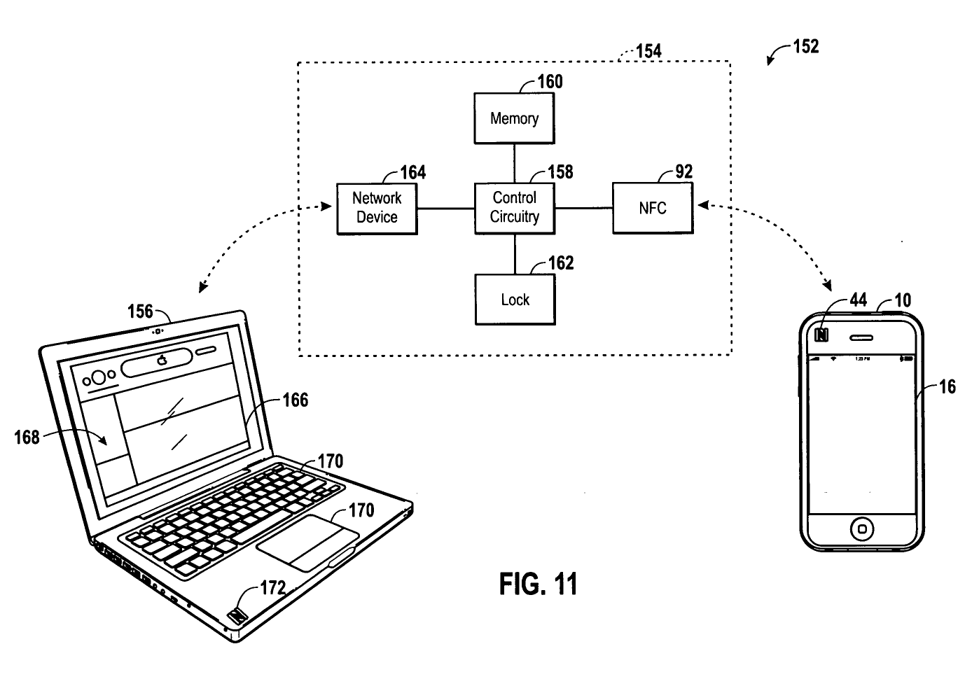

FIG. 11 illustrates a system 152 that may employ motion-based inputs to open a lock. The system 152 includes the device 10, an electronic device 154, and an external device 156. The device 10 may receive motion-based inputs, as described above with reference to FIGS. 3-9, and transmit the inputs to the electronic device 154. In certain embodiments, the electronic device 154 may be in communication with the external device 156 to allow programming of the electronic device 154. The electronic device 154 may be a stand-alone device incorporated into a locking system, such as a door for a home or automobile. The electronic device 154 also may be incorporated into an external device, such as the external device 86 shown in FIG. 10 that may represent a computer, personal data assistant, portable media player, cellular telephone, or the like.

The electronic device 154 may communicate with the device 10 through a near field communication link established by bringing the NFC interface 44 within a close range of the NFC interface 92. The electronic device 154 may include control circuitry 158 configured to control operation of the electronic device 154. A memory 160 may store machine-readable code for executing operations of the electronic device 154 and may store a code for accessing a lock 162 within the electronic device 154. The memory 160 may be a non-volatile storage type such as read-only memory (ROM), flash memory, an optical disk, a hard drive, or other non-volatile computer readable media.

The lock 162 may include a mechanical lock controlled by electronic means or may include a virtual lock that restricts access to the electronic device 154. For example, the lock 162 may be a mechanical or magnetic structure actuated by the control circuitry 158. The control circuitry 158 may be configured to verify a code, such as a combination or pin number, received from the device 10 and open the lock 162 upon verification. In other embodiments, the lock 162 may include machine-readable executable code and/or control logic configured to restrict access to the electronic device 154.

The electronic device 154 also may include a network device 164 that allows the device 154 to communicate with the external device 156 over a network, such as a LAN, PAN, WAN, or the Internet. The network device 164 may be a network controller or network interface card (NIC). The external device 156 may include a computer or other suitable control means. In certain embodiments, the external device 156 may not be required, and the functions of the external device 156 may be performed using electronic device 10.

The external device 156 may include a display 166 for displaying a GUI 168. A user may navigate through the GUI 168 using input features 170, such as a keyboard and touch pad. Through the GUI 168, a user may program the code for the lock 162. In certain embodiments, the GUI 168 may include a web service, such as iTunes®, to facilitate programming of the electronic device 154. For example, a code may be entered through the GUI 168 and transmitted to the electronic device 154 for storage in the memory 160. The GUI 168 also may be used to setup and provide security monitoring for the electronic device 154. For example, if an incorrect code is transmitted to the electronic device 154, the control circuitry 158 may transmit an alert to the external device 156. The external device 156 also may include an NFC interface 172 for enabling NFC communication with the electronic device 154 and/or the electronic device 10.

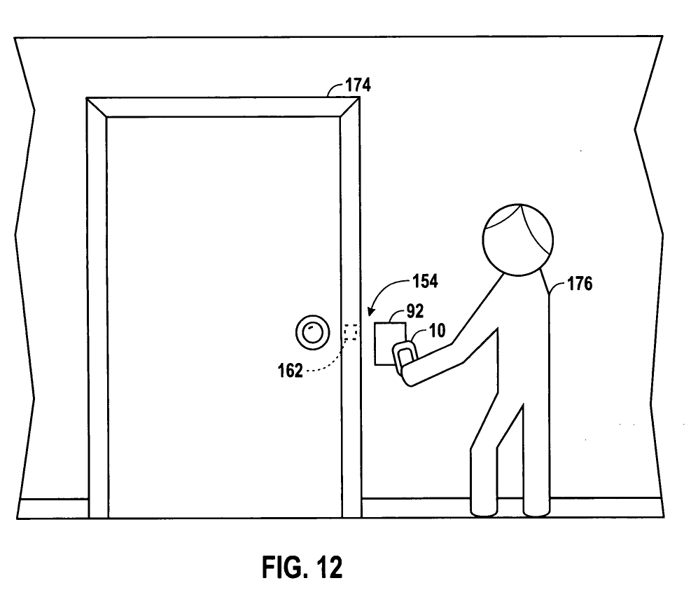

FIG. 12 illustrates one embodiment of the system 152 shown in FIG. 11. As illustrated, the electronic device 154 has been incorporated into a door 174. The lock 162 is disposed within a frame of the door and is configured to actuate to allow the door to open upon receipt of the correct code. The NFC interface 92 is disposed next to the door 174. The user 176 may bring the electronic device 10 in close proximity to the NFC interface 92 to enable communication between the electronic device 10 and the electronic device 154. The electronic device 10 may then be used to enter a motion-based input, such as a security code, and transmit the code to the NFC device 92. The motion-based input may be generated as discussed above with respect to FIGS. 3-9. Upon receipt of the code, the electronic device 154 may verify the code and actuate the lock if the code is correct.

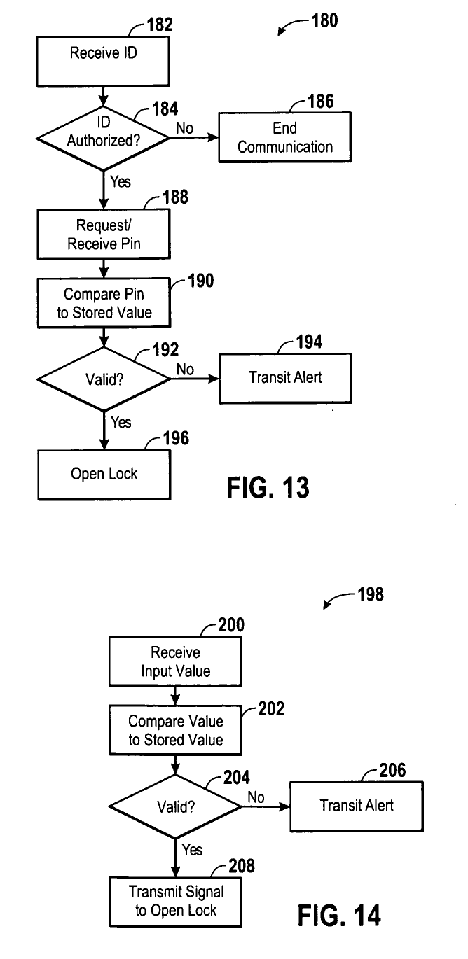

FIG. 13 illustrates a method 180 that the electronic device 154 may use to open a lock in accordance with one embodiment. The method 180 may begin by receiving (block 182) identification information from an electronic device, such as the electronic device 10 shown in FIG. 12. The identification information may include a serial number, cellular telephone number, or other identifier of the electronic device 10.

The device 154 (FIG. 12) may then determine if the identification information is authorized (block 184). For example, the control circuitry 158 (FIG. 11) may compare the received identification information to identification information stored in the memory 160 (FIG. 11). If the identification information is stored in the memory 160, then the device 154 may authorize communication with the electronic device 10. If the information is not present, the electronic device 154 may end communication (block 186) with the electronic device 10. However, if the communication is authorized, the electronic device 154 may request and receive a pin, or code, (block 188) from the electronic device 10.

The electronic device 154 may compare the pin to a code stored in the memory 160 of the electronic device 154 (block 190). The pin may include one or more numbers, motions, images, words, or a combination thereof. The electronic device 154 may then determine if the pin is valid (block 192) based on the comparison. If the code is not valid, the device may then transmit an alert (block 194) to the user. For example, the alert may be transmitted to an external device, such as the device 156, that is accessed by the user. In some embodiments, the device 156 may be configured to transmit the alert to the electronic device 10.

If the code is valid, the electronic device may open the lock (block 196). The method 180 may provide two levels of security for opening the lock 162 (FIG. 12). First, the electronic device 10 used to open the lock must be authorized, as specified by identification information contained in the memory 160. Second, the electronic device 10 must transmit a valid pin, or code.

The validation step also may occur within the electronic device 10. FIG. 14 illustrates a method 198 for verifying the pin within the electronic device 10. This method may be particularly useful when the pin is used to open a lock contained within the electronic device 10. The method 198 begins by receiving (block 200) an input value. The input value may be a single value such as a number, or a combination of numbers and/or motions generated using the techniques described above with respect to FIG. 8.

After receiving the input value, the electronic device 10 may compare the value to a stored value (block 202). The stored value may be contained within storage 48 of the electronic device 10. In certain embodiments, the stored value may be programmed using an external device, such as the device 156 shown in FIG. 11. Based on the comparison, the device 10 may determine if the input value is valid (block 204). The validation may be performed by the CPU 46 (FIG. 2).

If the input value is not valid, the electronic device 10 may transmit (block 206) an alert to the user. For example, the user may configure the electronic device to transmit the alert over a network to a home telephone or a computer. The alert may be in the form of a text message, voicemail, email, or the like. If the input value is valid, the electronic device may generate and transmit (block 208) a signal to open the lock. In embodiments where the lock 162 is not contained within the device 10, the device 10 may transmit the signal over a network connection or near field communication link.

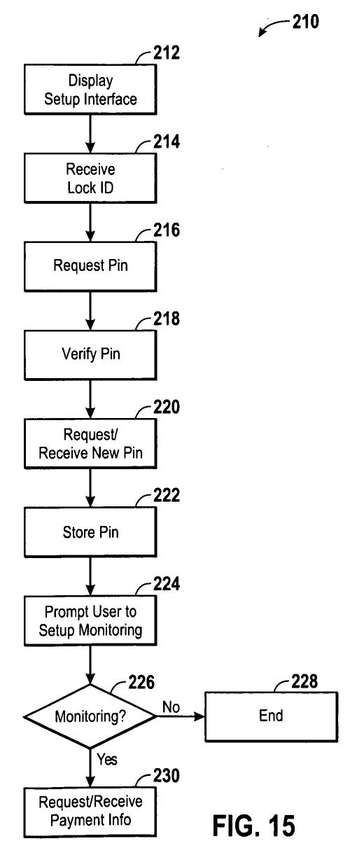

FIG. 15 illustrates a method for programming a pin for an electronic device, such as the device 154 as shown in FIG. 11. The method 210 begins by displaying (block 212) a setup interface. The setup interface may be part of a GUI and may be displayed on the device 154 or on an external device, such as the computer 156 shown in FIG. 11. In some embodiments, the setup interface may be accessed using a web service. The setup interface may prompt the user to enter identification information for the lock 162 (FIG. 11). The information may be transmitted using near field communication. For example, a NFC tag may be located on the packaging of a newly purchased lock and may be used to enter the lock identification information. The NFC tag may be brought within close proximity to the NFC interface 172 (FIG. 11) of the external device 156. In other embodiments, the lock identification information may be entered by a user through a user input structure 170 (FIG. 11), such as a keyboard.

In response to receiving (block 214) the lock identification information, the setup interface may prompt the user to enter a pin number (block 216) corresponding to the lock. The pin may be located within the packaging of a new lock, or for an existing lock, the pin number may have been selected by the user during a previous use. The pin may be entered by the user through input structures 170 (FIG. 11). The device 156 or 10 may then verify (block 218) the pin to ensure that the pin associated with the lock identification information. For example, the device 156 may compare the pin to a pin stored within a database maintained by the lock manufacturer or the setup interface provider. For example, when the lock is manufactured, the initial pin number and lock identification number may be stored in a database accessible by the web service. When a pin for an existing lock is changed by a user, the pin also may be transmitted to the database.

Once the pin is verified, the setup interface may then request and receive (block 220) a new pin. The new pin may be selected by the user and input through an input structure 170. The device 156 or 10 may then store the new pin (block 222), for example within a database accessible by the web service or within storage of the device. The application may then prompt the user to set up monitoring (block 224). As discussed above, the monitoring may provide notification to the user when a security breach has been detected, for example, the entry of an incorrect pin. The monitoring also may provide notification when the lock is not functioning properly. If monitoring is not desired (block 226) the process ends (block 228). However, if monitoring is desired, the application may prompt the user to enter payment information (block 230).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method, comprising:
displaying a user interface on a handheld device; and
varying the user interface based on contemporaneously acquired motion data to identify an input value.

2. The method of claim 1, wherein the varying the user interface comprises adjusting a first graphical element to align the input value with a second graphical element.

3. The method of claim 2, wherein the first graphical element comprises a pointer and the second graphical element comprises a stationary dial displaying the input value.

4. The method of claim 1, comprising transmitting the input value by near field communication to an external device.

5. The method of claim 1, comprising displaying an indication corresponding to the input value in response to a selection input.

6. The method of claim 5, wherein the selection input includes a motion-based input.

7. The method of claim 1, comprising acquiring the motion data from a one, two, or three axis accelerometer.

8. The method of claim 1, comprising transmitting the input value to open a lock.

9. The method of claim 1, comprising transmitting the input value to rotate a document displayed on an external device.

10. An electronic device, comprising:
a graphical user interface configured to facilitate selection of an input value; and
a processor configured to vary the user interface in response to acquired motion data to identify the input value.

11. The device of claim 10, comprising a near field communication channel configured to transmit the input value to an external device.

12. The device of claim 10, wherein the graphical user interface is configured to simulate rolling a die.

13. The device of claim 10, wherein the graphical user interface is configured to simulate opening a combination lock.

14. The device of claim 10, comprising a motion sensing device configured to acquire the motion data.

15. A system, comprising:
a handheld device configured to generate a motion-based input;
an electronic device configured to validate the motion-based input against a stored value and perform a function based on the input; and
an interface for determining the stored value.

16. The system of claim 15, wherein the electronic device includes a near field communication device for receiving the input.

17. The system of claim 15, wherein the electronic device is configured to authorize communication with the handheld device based on identification information received from the handheld device.

18. The system of claim 15, wherein the function includes at least one of opening a lock of the electronic device or adjusting an image displayed on the electronic device.

19. The system of claim 15, wherein the interface is included within the handheld device.

20. The system of claim 15, wherein the electronic device is configured to transmit an alert through the interface in response to a failed validation.

21. A method, comprising:
receiving a motion-based input from a handheld device over a near field communication channel; and
verifying the input to open a lock.

22. The method of claim 21, comprising verifying identification information received from the handheld device to authorize communication with the handheld device.

23. The method of claim 21, comprising transmitting a security alert if the verification fails.

24. The method of claim 21, wherein the input includes a three digit code with corresponding motion data.

25. A method, comprising:
displaying a user interface for controlling an external device from a handheld device;
varying the user interface in response to sensed motion of the handheld device to facilitate selection of an input value; and transmitting the input value by near field communication to the external device to control the external device.

26. One or more tangible media, comprising executable code configured to vary the display of one or more graphical elements in response to contemporaneously acquired motion data to identify an input value.

27. A method comprising:
identifying an input value on a handheld device based on contemporaneously acquired motion data; and
transmitting the input value to perform a function.

28. The method of claim 27, comprising establishing a communication link with an external device configured to perform the function.

29. The method of claim 28, comprising transmitting identification information to the external device to obtain authorization for transmitting the input value.

30. The method of claim 27, comprising:
sensing an external device; and
displaying an interface determined based on a property of the external device.
